(19) United States
(12) Patent Application Publication
(10) Pub. No.: US 2020/0385535 A1
(43) Pub. Date: Dec. 10, 2020

(54) COLOR MASTER BATCH ON THE BASIS OF VINYL CHLORIDE GRAFT COPOLYMERS

(71) Applicant: Vinnolit GmbH & Co. KG, Ismaning (DE)

(72) Inventor: Georg Haberl, Burghausen (DE)

(21) Appl. No.: 16/767,435

(22) PCT Filed: Nov. 26, 2018
(86) PCT No.: PCT/EP2018/082584

§ 371 Date: May 27, 2020

(30) Foreign Application Priority Data
Nov. 27, 2017 (EP) 17203874.7

(51) Int. Cl. C08J 3/22; C08L 51/00

(52) U.S. Cl. CPC C08J 3/226; C08L 51/003; C08L 2310/00; C08J 2427/06; C08J 2451/00; C08J 2327/06

(57) ABSTRACT

The present invention relates to the use of vinyl chloride graft copolymers for producing a color masterbatch and a color masterbatch based on vinyl chloride graft copolymers.

The present invention relates to the use of vinyl chloride graft copolymers for producing a color masterbatch as well as a color masterbatch based on vinyl chloride graft copolymers.

The term color masterbatch refers to plastic additives in the form of granules with levels of colorant that are higher than in the end use. They are added to the raw polymer for coloring.

For coloring of hard PVC (PVC-U) and soft PVC (PVC-P) in addition to liquid systems also waxes are used as carriers for the pigments. Color masterbatches based on PVC-P or universal carriers (for example with an EVA carrier) are also widespread. In JP 2000 230099 A, a color masterbatch is described, which contains a pigment and a lubricant based on acrylates (acrylic polymer lubricant) and optionally contains a PVC resin. This masterbatch is used among others for coloring vinyl chloride graft copolymers. In Examples 1 to 5 described in table 2 of JP 2000 230099 A a masterbatch is produced from 80 parts pigments, 20 or 50 parts METABLEN L-1000 and, optionally, 50 parts vinyl chloride resin. Subsequently, 1 to 1.5 parts of this masterbatch are used for coloring of 100 parts of the vinyl chloride graft copolymers described in Table 1 of JP 2000 230099 A.

In contrast to many other plastics, PVC is susceptible to additives, which affect its processing behavior. PVC formulations contain stabilizers, external and internal lubricants, processing aids and, depending on the application, fillers, antioxidants, UV absorbers, co-stabilizers and pigments. An unsuitable color masterbatch can severely interfere with the formulation optimized for the selected processing technology and the desired application.

The color masterbatches presently available on the markets are used with carriers which can adversely affect both processing and the final properties of the colored article. In this case, for example, the following disadvantages can occur:

Shifting of the rheology caused by a gliding effect, migration (in PVC-P), gloss reduction, reduction of mechanical properties, reduction of Vicat-softening temperature, plate-out, exudation (blooming), turbidity, specks by inadequate dispersing and gelling delay.

The object of the present invention was therefore to provide a color masterbatch which overcomes the disadvantages of the prior art.

It has now been surprisingly found that cross-linked vinyl chloride graft copolymerisates which are known to be thermoplastic elastomers from the EP 0 647 663 A1 are exceptionally well-suited as a carrier for color masterbatches.

The invention relates to the use of the vinyl chloride graft copolymers, described in EP 0647663 A1, as a carrier for color masterbatches which are especially useful for coloring PVC-U and PVC-P. Reference is expressly made to the vinyl chloride graft copolymers disclosed in EP 0 647 663 A1 and to their preparation.

The present invention relates to the use of vinyl chloride graft copolymer containing:

A) 35 to 60 wt-%, based on the total weight of the vinyl chloride graft copolymer, of a grafted, crosslinked copolymer, obtainable by copolymerisation of:
80 to 99.95 wt.-% vinyl chloride,
0.05 to 3.0 wt.-% polyethylenically unsaturated comonomers and
0 to 19.95% wt.-% of further copolymerizable, ethylenically unsaturated comonomers,
or
35 to 60 wt.-%, based on the total weight of the vinyl chloride graft copolymer, of a grafted (co)polymer obtainable by (co) polymerization of
80 to 100 wt.-% vinyl chloride and
0 to 20 wt.-% of further copolymerizable, ethylenically unsaturated comonomers, at a polymerisation temperature of 0 to 45° C.,
and
   B) 40 to 65 wt.-%, based on the total weight of the vinyl chloride graft copolymer, of a crosslinked graft base containing
a crosslinked acrylic ester copolymer having 0.01 to 5 wt.-% polyethylenically unsaturated comonomer units and optionally further comonomer units copolymerizable with acrylic esters for the production of a color masterbatch.

The vinyl chloride graft copolymer preferably contains 40 to 55 wt.-% of the grafted, crosslinked copolymer A) or of the grafted, uncrosslinked (co) polymer A) and 45 to 60 wt.-% of the crosslinked graft base B).

Polyethylenically unsaturated comonomers suitable for crosslinking the grafted vinyl chloride copolymer A) are those which have no conjugated double bonds, for example divinyl esters of dicarboxylic acids such as divinyl adipate; diallyl esters of polycarboxylic acids such as diallyl phthalate, diallyl fumarate; divinyl ethers of polyhydric alcohols such as ethylene glycol divinyl ether; divinyl aromates such as divinyl benzene; allyl and methallyl esters of ethylenically unsaturated monocarboxylic acids such as allyl methacrylate; di- and triacrylates of polyhydric alcohols such ethylene glycol dimethacrylate, propylene glycol dimethacrylate, diethylene glycol diacrylate (DEGDA), diethylene glycol dimethacrylate (DEGDMA), trimethylene glycol diacrylate, butylene glycol diacrylate, pentamethylene glycol diacrylat, glyceryl triacrylate, trimethylol propane triacrylate (TMPTA), trimethyol propane trimethacrylate (TMPTMA); tetraacrylates of polyhydric alcohols such as pentaerythritol tetraacrylate and triallyl cyanurate.

Diallyl phthalate, divinyl adipate, triallyl cyanurate, allyl methacrylate, ethylene glycol dimethacrylate, butylene glycol diacrylate, trimethylene glycol diacrylate and trimethyol propane triacrylate or mixtures thereof are preferred. Preferably, the amount of copolymerized crosslinker amounts to 0.1 to 1.5 wt.-%, based on the total weight of the grafted copolymer A).

In addition to vinyl chloride and optionally polyethylenically unsaturated comonomers, the grafted copolymer A) can contain one or more further copolymerized ethylenically unsaturated comonomers. Examples of these are vinyl esters of saturated carboxylic acids having 2 to 12 carbon atoms, such as vinyl acetate, vinyl propionate, vinyl laurate or vinyl versatate, (meth)acrylic esters of alcohols having 1 to 8 carbon atoms, such as methyl acrylate, methyl methacrylate, n-butyl acrylate, n-butyl methacrylate, t-butyl acrylate, 2-ethylhexyl acrylate; ethylenically unsaturated mono- and dicarboxylic acids such as acrylic acid, methacrylic acid, maleic acid, fumaric acid; mono- and diesters of ethylenically unsaturated dicarboxylic acids such as diisopropyl fumarate; vinyl aromatics such as styrene; and olefins such as ethylene.

The content of such comonomers should not exceed 5 wt.-%, based on the total weight of the copolymer A, in case that monomers are copolymerized, the homopolymers whereof have a glass transition temperature Tg<20° C. In case that monomers are copolymerized the homopolymers whereof have a glass transition temperature T₀≥20° C., the content thereof may be up to 20 wt.-%, based on the total weight of the copolymer A).

In case the grafted copolymer A) does not contain crosslinking comonomer units, it is preferred that grafting is carried out at a polymerization temperature which results in a K value ≥78 (DIN 53726) when vinyl chloride is homopolymerized to VC-polymers. This corresponds to a polymerization temperature of 0 to 45° C. (concerning the relationship between the polymerization temperature and the molecular weight of the polymer see also: PVC Handbook, C. E. Wilkes, J. W. Summers, C. A. Daniels (Eds), page 59, ISBN 3-446-22714-8).

The graft base used in the present invention contains a crosslinked acrylic acid ester copolymer having 0.01 to 5 wt.-% polyethylenically unsaturated comonomer units and optionally further copolymerizable comonomer units or mixtures of such copolymers.

Suitable acrylic ester copolymers are those of one or more acrylic esters of alcohols having 1 to 12 carbon atoms, such as, for example, methyl acrylate, ethyl acrylate, propyl acrylate, n-butyl acrylate, 2-ethylhexyl acrylate.

The term “polyethylenically unsaturated comonomer units” preferably refers to structural units which are obtained by reaction of the corresponding polyethylenically unsaturated comonomers. The term “comonomer units copolymerizable with acrylic acid esters” preferably refers to structural units which can be obtained by reaction of the corresponding comonomers which can be copolymerized with acrylic acid esters.

Suitable, polyethylenically unsaturated comonomer units can be based on the comonomers already mentioned above or can be prepared therefrom. Preferably, the crosslinked acrylate graft base contains 0.05 to 0.5 wt.-%, based on the total weight of the graft base, of copolymerized diallyl phthalate, divinyl adipate, triallyl cyanurate, allyl methacrylate, ethylene glycol dimethacrylate, butylene glycol diacrylate, trimethylene glycol diacrylate, trimethylol propane triacrylate or mixtures thereof.

Examples of further copolymerizable, ethylenically unsaturated comonomers are vinyl esters of saturated carboxylic acids having 2 to 12 carbon atoms, such as vinyl acetate, vinyl propionate, vinyl laurate or vinyl versatate; methacrylic acid esters of alcohols having 1 to 8 carbon atoms, such as methyl methacrylate, n-butyl methacrylate; ethylenically unsaturated mono- and dicarboxylic acids such as acrylic acid, methacrylic acid, maleic acid, fumaric acid; mono- and diesters of ethylenically unsaturated dicarboxylic acids such as diisopropyl fumarate; vinyl aromatics such as styrene; olefins such as ethylene; sulfonates such as vinyl sulfonate, 2-acrylamido-2-methyl propane sulfonate.

Crosslinked acrylic ester copolymers of n-butyl acrylate and/or 2-ethylhexyl acrylate are preferred. Crosslinked acrylic acid ester-ethylene-vinyl ester copolymers having an acrylic acid ester content of 35 to 70 wt.-%, an ethylene content of 10 to 30 wt.-% and a vinyl ester content of 20-50 wt.-%, based on the total weight of the copolymer B), are also preferred as the graft base B), in particular crosslinked copolymers containing n-butyl acrylate units, ethylene and vinyl acetate units. If appropriate, mixtures of said acrylic acid ester copolymers may also be present.

According to the present invention particularly preferred vinyl chloride graft copolymers are used, comprising:

A) 40 to 55 wt.-%, based on the total weight of the graft copolymers of a grafted crosslinked copolymer of
98.5 to 99.9 wt.-% of vinyl chloride and
0.1 to 1.5% of one or more polyethylenically unsaturated comonomers selected from the group of diallyl phthalate, allyl methacrylate, ethylene glycol dimethacrylate, butylene glycol diacrylate, trimethylene glycol diacrylate, trimethyol propane triacrylate,
   or
40 to 55 wt.-%, based on the total weight the graft vinyl chloride copolymer of a grafted VC polymer, obtainable by graft polymerization of vinyl chloride at a polymerization temperature of 0 to 45° C., and
   B) 45 to 60 wt.-%, based on the total weight of the graft copolymer, of a crosslinked graft base consisting of a crosslinked copolymer of n-butyl acrylate and/or 2-ethylhexyl acrylate, or of a crosslinked acrylic ester ethylene-vinyl acetate-copolymer with an acrylate content of 35 to 70 wt.-% or mixtures of the said copolymers, the copolymers being crosslinked with 0.05 to 0.5 wt.-% of one or more copolymerized, polyethylenically unsaturated comonomers selected from the group of diallyl phthalate, allyl methacrylate, ethylene glycol diacrylate, butylene glycol diacrylate, trimethylene glycol diacrylate, trimethyol propane triacrylate.

The preparation of the vinyl chloride graft copolymers to be used as a carrier is described in detail in EP 0 647 663 A1.

Furthermore, the present invention relates to a color masterbatch comprising the carrier described above and a pigment, and optionally further additives.

Further additives can include, for example, nanofillers, stabilizers, antistatic agents, flame retardants, adhesion promoters, nucleating agents, blowing agents, antibacterial agents and mixtures thereof. The amount of the additives is preferably 1 to 80 wt.-%, based on the weight of the vinyl chloride graft copolymer formed.

The color master batch according to the invention preferably contains no lubricant based on acrylates (acrylic polymer lubricants) such as METABLEN L-1000 from Mitsubishi Rayon Co.

For its use as a carrier for a color masterbatch according to the invention, the crosslinked vinyl chloride graft copolymer is mixed with at least one organic or inorganic pigment. For example, mixing is carried out in usual high-speed mixers conventionally used in PVC-Industry, preferably in a weight ratio from 80:20 to 20:80; particularly preferably from 75:25 to 25:75.

The mixture thus prepared may then be granulated in conventional equipment and thereby processed to a dust-free, easy to handle color masterbatch. The size of the granules can vary.

Both inorganic and organic pigments are suitable as pigments. The inorganic pigments include those of the group of oxides, e.g. iron oxide (brown, red, black), chromium oxide (green), titanium dioxide, or carbon e.g. carbon-black, or chromates such as lead chromate yellow, molybdate orange, or complexes of inorganic colored pigments, such C.I. Pigment Brown 24, haematite chrome oxide, cobalt blue, nickel titanate yellow, C.I. Pigment Yellow 119, bismuth vanadate yellow, or sulfides such as cadmium sulfide (yellow, orange, red), cerium sulfide (yellow, orange, red), ultramarine (violet, blue), zinc sulfide (white). Organic pigments include azo pigments, e.g. lacked azo pigments (yellow, red), disazo pigments (yellow, orange, red), disazo condensation pigments (yellow, red), benzimidazole pigments (yellow, orange), metal complex pigments (yellow), insoindoline pigments (yellow), insoindolinone pigments (yellow), or also polycyclic pigments, e.g. quinacridone (violet, blue), quinophthalone (yellow), diketo-pyrrolo-pyrrole (orange, red, violet), disoxazine pigments (violet), indanthrone (blue), perylene (red, violet), phthalocyanine (blue, green). As dyes both soluble dyes, such as anthraquinone, quinophthalone, pyrazolone, perinone and mono azo dyes, and fluorescent dyes, e.g. perylene, naphthalimide, cumine derivates, thioindigo, thioxanthene benzanthrone can be used.

The color masterbatch according to the invention contains carrier and pigment preferably in a weight ratio of 80:20 to 20:80; particularly preferred from 75:25 to 25:75.

The (heat and light) stabilizers (Ca/Zn, Ba/Zn, Sn organic stabilizers) customarily employed for the stabilization of PVC are, as known to the skilled person, put in the mixer and the total mixture is heated by friction to the appropriate temperature (up to 150° C.). The stabilizers are added in customary amounts of preferably 1.0 to 5.0 wt.-% based on the vinyl chloride polymer (VC polymer).

If required the VC polymers can also contain fillers like chalk, quartz powder, talc, or further pigments, such as e.g. titanium dioxide or carbon black. These fillers and/or further pigments are preferably used in amounts of 5 to 100 wt.-%, based on the VC polymer.

To improve the melting rheology, internal lubricants, preferably in amounts of 0.1 to 1.0 wt.-% based on the VC polymer, can optionally be added to the PVC compositions. Examples are fatty acid partial esters of glycerin such as glycerol mono oleate, or phthalic acid esters of fatty alcohols like distearyl phthalate.

The color masterbatch according to the invention can also be used in plasticized PVC formulations containing plasticizers. Suitable plasticizers are, for example, phthalic acid esters such as dioctyl phthalate, adipic acid esters such as di-2-ethylhexyl adipate or phosphoric acid esters such as diphenyl-2-ethylhexyl phosphate, or plasticizing polymers such as ethylene-vinyl acetate copolymers, ethylene-vinyl acetate carbon monoxide-terpolymers and thermoplastic polyurethane.

It is preferred to use the color master batch according to the invention in rigid PVC formulations that are free of plasticizers. To improve the melting rheology these may optionally contain polymeric processing aids such as, for example, copolymers of methyl methacrylate and styrene or butyl acrylate, preferably in amounts of 0.5 to 5 wt.-%, based on the PVC content, or also internal lubricants in the above mentioned quantities.

### EXAMPLES

The following color master batches were prepared:

### Extruder: Weber DS 85 16 D, S-Screw

| | | |
|---|---|---|
| Temperatures: | cylinder zone 1 | 150° C., |
| | Cylinder zone 2 | 160° C. |
| | Cylinder zone 3 | 170° C. |
| | Cylinder zone 4 | 170° C. |
| | Cylinder zone 5 | 175° C. |
| | Cylinder zone 6 | 175° C. |

Screw speed 30 rpm; Dosing screw speed 4 rpm

A pelletizing head was used as the tool.

TABLE 1

| Ingredient | example 1 | example 2 |
|---|---|---|
| Trade name - trade type | HA 3350/6 | HA 3350/7 |
| K 707 E (Vinnolit) | 30.0000 | 70.0000 |
| Heucodur Brown 869 | 70.0000 | — |
| Heucodur Yellow 3975 | — | 30.0000 |
| Mark CZ 2001/1 (Ca/Zn stabilizer) | 1.2500 | 1.2500 |
| Edenol D 81 (epoxidized soybean oil) | 1.5000 | 1.5000 |
| Paraloid K 120 N (acrylic processing aid) | 1.0000 | 1.0000 |
| Loxiol G 70 (lubricant) | 0.2500 | 0.2500 |

Carrier according to the invention: K 707 E; Pigments: Heucodur Brown 869 and Heucodur Yellow 3975; Stabilizers: Mark CZ 2001/1 and Edenol D 81; Processing aid: Paraloid K 120 N; lubricating agent: Loxiol G 70.

Window profiles were manufactured with these color masterbatches according to the invention. The compositions are shown in Table 2:

### Extruder: Cincinnati CMT-45, Screw Konical Counter Rotating

Temperatures: screw 155-160° C.

| | |
|---|---|
| Cylinder zone 1 | 165° C. |
| Cylinder zone 2 | 170° C. |
| Cylinder zone 3 | 180° C. |
| Cylinder zone 4 | 195° C. |
| Tool | 206° C. |

Screw speed 22 rpm
Window profile-tool

TABLE 2

| | Reference Ex | | | | | | | | |
|---|---|---|---|---|---|---|---|---|---|
| | (without | | | | | Comp.- | Comp.- | Comp.- | Comp.- |
| | pigment) | Ex. 3 | Ex. 4 | Ex. 5 | Ex. 6 | Ex. 1 | Ex. 2 | Ex. 3 | Ex. 4 |
| Ingredient | | | | | | | | | |
| Vinnolit S 3268 | 95 | 95 | 95 | 95 | 95 | 95 | 95 | 95 | 95 |
| S-PVC | | | | | | | | | |
| Vinnolit K 707 | 10 | 10 | 10 | 10 | 10 | 10 | 10 | 10 | 10 |
| E Graft | | | | | | | | | |
| copolymer | | | | | | | | | |
| Bäropan R | 3.6 | 3.6 | 3.6 | 3.6 | 3.6 | 3.6 | 3.6 | 3.6 | 3.6 |
| 90901 stabilizer | | | | | | | | | |
| Kronos 2220 | 4 | without | without | without | without | without | without | without | without |
| Titanium | | | | | | | | | |
| dioxide | | | | | | | | | |
| Hydrocarb 95T | 8 | 8 | 8 | 8 | 8 | 8 | 8 | 8 | 8 |
| chalk | | | | | | | | | |
| Yellow -HA | | 4 | 6 | | | | | | |
| 3350/7 | | | | | | | | | |
| Brown-HA | | | | 4 | 6 | | | | |
| 3350/6 | | | | | | | | | |
| Heucobatch | | | | | | 4 | 6 | | |
| Yellow | | | | | | | | | |
| 190 07 99 | | | | | | | | | |
| Heucobatch | | | | | | | | 4 | 6 |
| Brown 890 103 | | | | | | | | | |
| Test method | | | | | | | | | |
| Impact strength | 24.38 | 100.79 | 102.04 | 23.8 | 101.81 | 18.33 | 17.28 | 24.03 | 18.33 |
| (DIN ISO 179- | | | | | | | | | |
| 1, 23° C.) | | | | | | | | | |
| Gloss | 50.9 | 47.4 | 50.6 | 49.3 | 50.8 | 35.2 | 35.2 | 34.7 | 34.2 |
| (DIN ISO | | | | | | | | | |
| 67530, 60° C.) | | | | | | | | | |
| Impact strength | 53.0 | 54.0 | 55.2 | 52.0 | 52.7 | 36.8 | 25.1 | 48.9 | 48.9 |
| (RAL716-1, | | | | | | | | | |
| 23° C.) | | | | | | | | | |
| Vicat A | 89.0 | 89.1 | 88.6 | 88.5 | 88.6 | 88.0 | 87.5 | 86.5 | 87.5 |
| (DIN EN ISO | | | | | | | | | |
| 306) Mean ° C. | | | | | | | | | |

By using the color masterbatches produced in accordance with the invention (examples 3, 4, 5, 6), the impact strength remains at a high level or is further improved. In contrast to the comparative examples (see comp. Ex. 1, 2, 3, 4), the high gloss of the extrudates desired in many cases is retained.

A particularly high Vicat softening temperature is sought, especially for pigmented articles for outdoor use. The use of the color masterbatches produced according to the invention proved to be advantageous here.

1-12. (canceled)

13. A method for production of a color masterbatch, comprising:
using a vinyl chloride graft copolymer comprising:
A) 35 to 60 wt.-%, based on the total weight of the vinyl chloride graft copolymer, of a grafted, crosslinked copolymer which can be prepared by copolymerizing:
80 to 99.95 wt.-%, vinyl chloride,
0.05 to 3.0 wt.-% polyethylenically unsaturated comonomers and
0 to 19.95 wt.-% copolymerizable, ethylenically unsaturated comonomers,
or
35 to 60 wt.-%, based on the total weight of the vinyl chloride graft copolymer, of a grafted (co)polymer, obtainable by (co) polymerization of
80 to 100 wt.-% vinyl chloride and
0 to 20 wt.-% of further copolymerizable, ethylenically unsaturated comonomers, at a polymerization temperature of 0 to 45° C.,
and
B) 40 to 65 wt.-%, based on the total weight of the vinyl chloride graft copolymer of a crosslinked graft base containing
a crosslinked acrylate copolymer with 0.01 to 5 wt.-% polyethylenically unsaturated comonomer units and, if appropriate, further comonomer units copolymerizable with acrylic acid esters.

14. The method of claim 13 wherein the polyethylenically unsaturated comonomers do not contain conjugated double bonds like divinyl esters of dicarboxylic acids such as divinyl adipate; diallyl esters of polycarboxylic acids such as diallyl phthalate, diallyl fumarate; divinyl ethers of polyhydric alcohols such as ethylene glycol divinyl ether; divinyl aromates such as divinyl benzene; allyl and methallyl esters of ethylenically unsaturated monocarboxylic acids such as allyl methacrylate; di- and triacrylates of polyhydric alcohols such as ethylene glycol dimethacrylate, propylene glycol dimethacrylate, diethylene glycol diacrylate (DEGDA), diethylene glycol dimethacrylate (DEGDMA), trimethylene glycol diacrylate, butylene glycol diacrylate, pentamethylene glycol diacrylate, glyceryl triacrylate, trimethylol propane triacrylate (TMPTA), trimethyol propane trimethacrylate (TMPTMA); tetraacrylate of polyhydric alcohols such as pentaerythritol tetraacrylate; triallyl cyanurate.

15. The method of claim 13 wherein the polyethylenically unsaturated comonomers are selected from diallyl phthalate, divinyl adipate, triallyl cyanurate, allyl methacrylate, ethylene glycol dimethacrylate, butylene glycol diacrylate, trimethylene glycol diacrylate and trimethyol propane triacrylate or mixtures thereof.

16. The method of claim 13 wherein the further copolymerizable, ethylenically unsaturated comonomers are selected from: vinyl esters of saturated carboxylic acids having 2 to 12 carbon atoms such as vinyl acetate, vinyl propionate, vinyl laurate or vinyl versatic acid esters; (meth) acrylic acid esters of alcohols having 1 to 8 carbon atoms, such as methyl acrylate, methyl methacrylate, n-butyl acrylate, n-butyl methacrylate, t-butyl acrylate, 2-ethylhexyl acrylate; ethylenically unsaturated mono and dicarboxylic acids such as acrylic acid, methacrylic acid, maleic acid, fumaric acid; mono- and diesters of ethylenically unsaturated dicarboxylic acids such as diisopropyl fumarate; vinyl aromatics such as styrene; and olefins such as ethylene.

17. The method of claim 13 wherein the crosslinked acrylate copolymer is prepared from one or more acrylic acid esters of alcohols having 1 to 12 carbon atoms, such as methyl acrylate, ethyl acrylate, propyl acrylate, n-butyl acrylate, 2-ethylhexyl acrylate.

18. The method of claim 13 wherein the vinyl chloride graft copolymer comprises:
A) 40 to 55 wt.-%, based on the total weight of the graft copolymer, of a grafted crosslinked copolymer of
98.5 to 99.9 wt.-% vinyl chloride and
0.1 to 1.5 wt.-% of one or more polyethylenically unsaturated comonomers selected from the group consisting of diallyl phthalate, allyl methacrylate, ethylene glycol dimethacrylate, butylene glycol diacrylate, trimethylene glycol diacrylate, trimethyol propane triacrylate,
or
40 to 55 wt.-%, based on the total weight of the vinyl chloride graft copolymer, of a grafted VC polymer, obtainable by graft polymerization of vinyl chloride at a polymerization temperature of 0 to 45° C., and
B) 45 to 60 wt.-%, based on the total weight of the graft copolymer, of a crosslinked graft base consisting of a crosslinked copolymer of n-butyl acrylate and/or 2-ethylhexyl acrylate, or of a crosslinked acrylic acid ester-ethylene-vinyl acetate copolymer having an acrylate content of 35 to 70 wt.-% or mixtures of said copolymers, whereby the copolymers are crosslinked with 0.05 to 0.5 wt.-% of one or more copolymerized, polyethylenically unsaturated comonomers selected from the group consisting of diallyl phthalate, allyl methacrylate, ethylene glycol dimethacrylate, butylene glycol diacrylate, trimethylene glycol diacrylate, trimethyol propane triacrylate, for the production of a color masterbatch.

19. The method of claim 13 wherein the vinyl chloride graft copolymer is admixed with at least one pigment.

20. A color masterbatch comprising
a vinyl chloride graft copolymer comprising:
A) 35 to 60 wt.-%, based on the total weight of the vinyl chloride graft copolymer, of a grafted, crosslinked copolymer obtainable by copolymerization of:
80 to 99.95 wt.-% vinyl chloride,
0.05 to 3.0 wt.-% polyethylenically unsaturated comonomers and
0 to 19.95 wt.-% of further copolymerizable, ethylenically unsaturated comonomers,
or
35 to 60 wt.-%, based on the total weight of the vinyl chloride graft copolymer, of a grafted (co) polymer which can be prepared by (co) polymerizing
80 to 100 wt.-% vinyl chloride and
0 to 20 wt.-% of further copolymerizable, ethylenically unsaturated comonomers, at a polymerization temperature of 0 to 45° C.,
and
B) 40 to 65 wt.-%, based on the total weight of the vinyl chloride graft copolymer of a crosslinked graft base containing
a crosslinked acrylic acid ester copolymer containing 0.01 to 5 wt.-% of polyethylenically unsaturated comonomer units and, if appropriate, further comonomers which can be copolymerized with acrylic acid esters,
and at least one pigment.

21. A color masterbatch according to claim 20 comprising:
a vinyl chloride graft copolymer comprising:
A) 40 to 55 wt.-%, based on the total weight of the graft copolymer, of a grafted crosslinked copolymer of
98.5 to 99.9 wt.-% of vinyl chloride and
0.1 to 1.5 wt.-% of one or more polyethylenically unsaturated comonomers selected from the group consisting of diallyl phthalate, allyl methacrylate, ethylene glycol dimethacrylate, butylene glycol diacrylate, trimethylene glycol diacrylate, trimethyol propane triacrylate,
or
40 to 55 wt.-%, based on the total weight of the vinyl chloride graft copolymer, of a grafted VC polymer obtainable by graft polymerization of vinyl chloride at a polymerion temperature from 0 to 45° C.,
and
B) 45 to 60 wt.-% based on the total weight of the graft copolymer, of a crosslinked graft base consisting of a crosslinked copolymer of n-butyl acrylate and/or 2-ethylhexyl acrylate, or of a crosslinked acrylic acid ester-ethylene-vinyl acetate copolymer with an acrylate content of 35 to 70 wt.-% or mixtures of the copolymers mentioned, wherein the copolymers are crosslinked with 0.05 to 0.5 wt.-% of one or more copolymerized, polyethylenically unsaturated comonomers selected from the group consisting of diallyl phthalate, allyl methacrylate, ethylene glycol dimethacrylate, butylene glycol diacrylate, trimethylene glycol diacrylate, trimethyol propane triacrylate,
and at least one pigment.

22. The method of claim 13 wherein the vinyl chloride graft copolymer and at least one pigment are admixed in weight ratio of 80:20 to 20:80.

23. The method of claim 13 wherein the vinyl chloride graft copolymer and at least one pigment are admixed at a weight ratio of 75:25 to 25:75.

24. The method of claim 13 wherein a color masterbatch produced that comprises the vinyl chloride graft copolymer and at least one pigment in weight ratio of 80:20 to 20:80.

25. The method of claim 13 wherein a color masterbatch is produced that comprises the vinyl chloride graft copolymer and at least one pigment at a weight ratio of 75:25 to 25:75.

26. A color masterbatch according to claim 20 wherein the vinyl chloride graft copolymer and the pigment are contained in a weight ratio of 80:20 to 20:80.

27. A color masterbatch according to claim 20 wherein the vinyl chloride graft copolymer and the pigment are contained in a weight ratio of 75:25 to 25:75.
